(19) United States
(12) Patent Application Publication
(10) Pub. No.: US 2015/0234375 A1
(43) Pub. Date: Aug. 20, 2015

(54) TOOL COORDINATE SYSTEM CORRECTING METHOD OF ROBOT SYSTEM, AND ROBOT SYSTEM

(71) Applicant: CANON KABUSHIKI KAISHA, Tokyo (JP)

(72) Inventor: Hiroyuki Takayama, Tokyo (JP)

(21) Appl. No.: 14/614,786

(22) Filed: Feb. 5, 2015

(30) Foreign Application Priority Data
Feb. 20, 2014 (JP) 2014-030598

(51) Int. Cl. G05B 19/19

(52) U.S. Cl. CPC G05B 19/19; G05B 2219/33259; Y10S 901/02; Y10S 901/41

(57) ABSTRACT

An axial offset correcting method of a tool coordinate system of a robot also including an inclination offset correction is provided. A first workpiece is grasped by a tool. The operation of a robot arm is controlled by using detecting quantities of a force sensor, thereby starting a fitting of the first workpiece into a second workpiece. A position of an origin of a mechanical interface coordinate system in at least two different states during the fitting operation is obtained, thereby obtaining a position of a central axis of the first workpiece. An inclination offset quantity of the tool coordinate system is calculated based on the position of the central axis of the first workpiece. An inclination offset of the tool coordinate system is corrected based on the calculated inclination offset quantity.

### BACKGROUND OF THE INVENTION

1. Field of the Invention

The present invention relates to a robot arm in which a tool has been mounted to an edge, a force sensor for detecting a force and a torque exerted on a workpiece grasped by the tool, and a robot system.

2. Description of the Related Art

In recent years, a request for automatization using a robot system has been increasing to an assembling of industrial products having a small and complicated structure. There is a case where an assembling accompanied with a complicated operation and accurate force control is necessary in the assembling of those products.

In consideration of such a demand, a force sensor controlling robot system has conventionally been known. In such a kind of apparatus, an end effector for allowing a specific operation or work to be executed is mounted to an edge of a robot arm of multi-axis (a few axes, for example, 6 axes) and multi-joint. Various kinds of tools such as spray gun for painting, welding gun, nut tightener, and the like are included in the end effector. A tool constructing a grasping portion for grasping an object such as a workpiece (part) or the like is called “robot hand” or the like.

In particular, in the case where a robot hand (hereinbelow, also referred to as a hand) is used, the tool is mounted to an edge of a robot arm through a force sensor. The force sensor detects a force and a torque exerted through a workpiece and its detecting quantities are used to control the operation (position, position and orientation, velocity, and the like) of the robot arm or tool. Such control is called “force controlling”. The mounting portion (for example, flange surface or the like of the robot arm edge) of the tool such as a hand or the like is, particularly, called “mechanical interface” or the like.

In such a robot system, a position and a motion of each unit such as robot arm, tool (end effector), or the like are controlled through a controlling apparatus constructed by using a computer, a memory, and the like. In this case, the position and motion of each unit are controlled by using a coordinate system such as base coordinate system, mechanical interface coordinate system, tool coordinate system (end effector coordinate system), or the like as a reference. The base coordinate system among them becomes a reference of the whole robot system and is arranged by using a mounting surface or the like of the base of the robot as a reference. The mechanical interface coordinate system is a coordinate system in which a mounting surface of the end effector (tool) is used as a reference.

The tool coordinate system (end effector coordinate system) is a coordinate system which is used for drive control of the tool, and is used to control, particularly, the position and the position and orientation of each unit of the tool. The tool coordinate system is set to a predetermined position of an edge of the end effector (tool) on the basis of data showing the position and the position and orientation of an edge of the end effector when seen from the mechanical interface. Ordinarily, the tool coordinate system is set to a predetermined position in accordance with a structure of the end effector (tool) or design dimensions of claws or the like which are mounted to the edge.

In such a kind of robot system, a plurality of workpieces (parts) can be coupled in accordance with a specific coupling relation, and in the case of coupling the workpieces in accordance with, for example, a fitting relation, the following control is made.

For example, in the case of precisely fitting cylindrical parts having concave and convex cross sectional shapes with specific phases, first, by rotating an edge portion of the robot arm, the phases of the cylindrical parts are equalized and, thereafter, the fitting operation is executed. Specifically speaking, first, the grasped cylindrical part is moved to a position where a central axis of the cylindrical part grasped by the end effector mounted to the edge of the robot arm and a central axis of the cylindrical part at a fitting destination coincide. Subsequently, the edge portion of the robot arm is rotated around a specific axis of the tool coordinate system (end effector coordinate system) as a center in such a manner that the phase of the grasped cylindrical part and the phase of the cylindrical part at the fitting destination coincide. After that, a precise fitting by the force control is performed.

Hitherto, as related arts regarding an axial offset correction of the tool coordinate system, a method using an image processing apparatus (see Japanese Patent No. 4289619), a method using a micro displacement gauge (see Japanese Patent Application Laid-Open No. H01-58490), and the like have been proposed.

According to Japanese Patent No. 4289619, a workpiece having a marker which can be detected by the image processing apparatus is grasped by an end effector of a robot, an offset of a marker position accompanied with a movement of an arm is detected by the image processing apparatus, and an offset of a grasping point of the end effector to an edge axis of the arm is calculated. According to Japanese Patent Application Laid-Open No. H01-58490, by using the two micro displacement gauges and cylindrical jigs, an edge axis of a robot arm is rotated, signals of the micro displacement gauges are read, and the edge axis of the robot arm is calibrated on the basis of the read information.

However, in both of the above methods disclosed in Japanese Patent No. 4289619 and Japanese Patent Application Laid-Open No. H01-58490, only a horizontal offset correction of the tool coordinate system is performed.

However, there is a case where the central axis of the cylindrical part grasped by the hand and the rotation central axis of the tool coordinate system which was set on the basis of the design dimensions do not coincide due to an influence of a dimension tolerance, mounting precision, and the like of each part such as an end effector and the like. If the operation of the part in which an offset has occurred in the rotation central axis of the tool coordinate system as mentioned above is performed, there is such a risk that a load to each workpiece and a tact which is required for fitting increase and a trouble such as scraping of each workpiece, delay of the tact, or the like occurs.

A state where an offset of an inclination has occurred between the central axis of the part grasped by the hand and the rotation central axis of the tool coordinate system can occur in accordance with working accuracy and shapes of the claws of the hand and the part which is operated (or this is true of a jig) and characteristics such as affinity and the like. If such an inclination offset of the tool coordinate system occurs after a programming using the jig (master workpiece), it is considered that the inclination offset occurs with the same tendency even when the operation is executed to a workpiece of the same shape.

It is an aspect of the invention to enable an axial offset correction of a tool coordinate system including both of the foregoing horizontal offset correction and inclination offset correction mentioned above to be performed.

### SUMMARY OF THE INVENTION

According to an aspect of the present invention, a method of correcting a tool coordinate system of a robot system comprises a robot arm having a mounting surface on which a tool is mounted to be driven under a control using a tool coordinate system, and being controlled according to a mechanical interface coordinate system correlated to the mounting surface, a force sensor, and a controlling apparatus configured to control an operation of the robot arm, wherein, using a first workpiece having a convex potion and a second workpiece having a concave portion capable of fitting the convex portion, the first workpiece is grasped by the tool, to fit the concave portion of the first workpiece to the concave portion of the second workpiece, and wherein, under a controlling by the controlling apparatus, the method comprises: grasping the first workpiece by the tool; controlling the operation of the robot arm based on a detecting quantity of the force sensor, to start the fitting of the first workpiece to the second workpiece, to calculate a position of an origin of the mechanical interface coordinate system at least at two states during the operation of the fitting, to calculate a position of a central axis of the first workpiece; calculating an offset quantity of an inclination of the tool coordinate system based on the position of the central axis of the first workpiece; and correcting the offset quantity of the inclination of the tool coordinate system based on the calculated offset of the inclination.

According another aspect of the present invention, a robot system comprises: a robot arm having a mounting surface on which a tool is mounted to be driven under a control using a tool coordinate system, and being controlled according to a mechanical interface coordinate system correlated to the mounting surface; a force sensor; and a controlling apparatus configured to control an operation of the robot arm, wherein, using a first workpiece having a convex potion and a second workpiece having a concave portion capable of fitting the convex potion, the first workpiece is grasped by the tool, to fit the concave portion of the first workpiece to the concave portion of the second workpiece, and wherein the controlling apparatus controls such that the first workpiece is grasped by the tool, the operation of the robot arm is controlled based on a detecting quantity of the force sensor, to start the fitting of the first workpiece to the second workpiece, to calculate a position of an origin of the mechanical interface coordinate system at least at two states during the operation of the fitting, to calculate a position of a central axis of the first workpiece, an offset quantity of an inclination of the tool coordinate system is calculated based on the position of the central axis of the first workpiece, and the offset quantity of the inclination of the tool coordinate system is corrected based on the calculated offset of the inclination.

Further features of the present invention will become apparent from the following description of exemplary embodiments with reference to the attached drawings.

### BRIEF DESCRIPTION OF THE DRAWINGS

FIG. 1 is a perspective view schematically illustrating a whole construction of a robot system according to an embodiment of the invention.

FIG. 2 is a block diagram of a controlling apparatus according to the embodiment of the invention.

FIG. 3 is an explanatory diagram illustrating an outline of a coordinate system which is used in the robot system according to the embodiment of the invention.

FIG. 4 is a flowchart showing an axial offset correcting method according to the embodiment of the invention.

FIG. 5 is an explanatory diagram schematically illustrating a state before the inclination offset calculating operation is started.

FIG. 6 is an explanatory diagram schematically illustrating a state where a master workpiece has been inserted into a middle position when the inclination offset calculating operation is executed.

FIG. 7 is an explanatory diagram schematically illustrating a state where the insertion of the master workpiece has been completed when the inclination offset calculating operation is executed.

FIG. 8 is an explanatory diagram schematically illustrating a state before the horizontal offset calculating operation is started.

FIG. 9 is an explanatory diagram schematically illustrating a state where the master workpiece has been pressed in the X direction when the horizontal offset calculating operation is executed.

FIG. 10 is an explanatory diagram schematically illustrating a state where the master workpiece has been pressed in the Y direction when the horizontal offset calculating operation is executed.

### DESCRIPTION OF THE EMBODIMENTS

Preferred embodiments of the present invention will now be described in detail in accordance with the accompanying drawings.

In order to solve the foregoing problem, it is necessary to correct a rotation central axis of a tool coordinate system so that the rotation central axis of the tool coordinate system and a central axis of a grasped cylindrical part coincide. In order to realize such a correction, it is necessary to correct only an inclination of the rotation central axis of the tool coordinate system so as to coincide with an inclination of the central axis of the grasped cylindrical part and to correct an offset of a distance from the central axis of the grasped cylindrical part to the rotation central axis of the tool coordinate system.

Such an operation that only the inclination of the rotation central axis of the tool coordinate system is corrected so as to coincide with the inclination of the central axis of the cylindrical part grasped by the tool (end effector) is called “inclination offset correction” hereinbelow. Such an operation that only the offset of the distance from the central axis of the grasped cylindrical part to the rotation central axis of the tool coordinate system is called “horizontal offset correction” hereinbelow. Further, such an operation that both of “inclination offset correction” and “horizontal offset correction” of the rotation central axis of the tool coordinate system are executed so that the rotation central axis coincides with the central axis of the grasped cylindrical part is called “axial offset correction” hereinbelow.

If such an axial offset correction as mentioned above can be performed at a stage of a programming of a robot arm using, for example, a workpiece, much desirably, a master workpiece (jig) and stored as a correction (calibration) quantity, it is desirable. It is considered that by exerting the stored correction (calibration) quantity when the workpiece, much desirably, the workpiece correlated to the master workpiece (jig) is actually operated, such a trouble as mentioned above can be avoided.

An axial offset correcting method of the tool coordinate system of a robot according to the embodiment of the invention will be described hereinbelow with reference to the drawings.

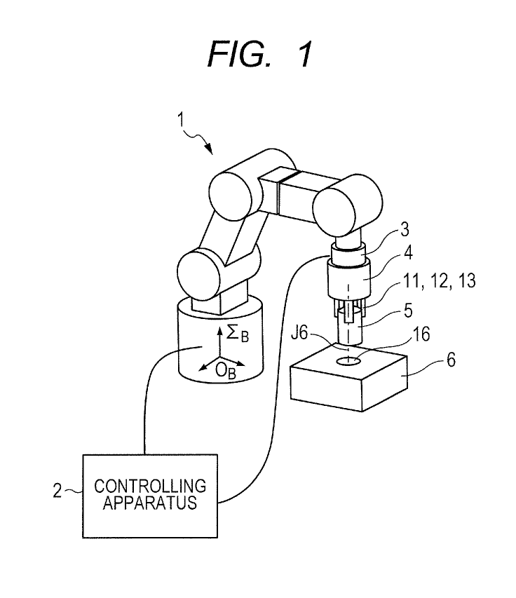

First, a whole construction of the robot system according to the embodiment of the invention will be described with reference to FIG. 1. FIG. 1 is a perspective view schematically illustrating the whole construction of the robot system according to the embodiment of the invention.

As illustrated in FIG. 1, the robot system according to the embodiment has: a robot arm 1 of 6 axes and vertical multi-joint; a controlling apparatus 2 for controlling the robot arm 1; a force sensor 3; and a tool 4 which can grasp a workpiece.

In FIG. 1, the robot arm 1 fixed onto a platform (not shown) has six actuators (not shown) each of which rotates each joint around each joint axis. By selectively driving each of the six actuators through the controlling apparatus 2, the robot arm 1 can move the tool 4 to an arbitrary 3-dimensional position.

The tool 4 has: three claws 11, 12, and 13 which can grasp the workpiece; and actuators (not shown) for driving the claws 11 to 13. The tool 4 is mounted to an edge of the robot arm 1. The tool 4 is mounted to the edge portion of the robot arm through the force sensor for detecting a force and a torque exerted on the workpiece grasped by the tool 4. The claws 11, 12, and 13 of the tool 4 are constructed so as to be movable toward a center of an edge axis of the robot arm 1 by the driving of the actuators. The claws 11, 12, and 13 are come into contact with or removed from the center of an edge axis J6 serving as a grasping center, so that they are opened or closed and sandwich and grasp the workpiece or the like. For example, by moving the three claws 11 to 13 of the tool 4 toward the center of the edge axis J6, the workpiece or the like is grasped. By removing the claws 11, 12, and 13 from the center of the edge axis J6, the workpiece or the like is released.

A servo motor or a stepping motor can be used as an actuator for rotating each joint of the robot arm 1. A stepping motor or the like can be used as an actuator for driving each of the claws 11 to 13 of the tool 4. Sensor devices such as rotary encoders or the like can be used to detect present positions and positions and orientation of each joint of the robot arm 1 and the claws 11 to 13 of the tool 4.

The force sensor 3 is constructed by a sensor device which can detect a force in the triaxial direction exerted on each of the three claws 11, 12, and 13 of the tool 4 and a triaxial moment. As a force sensor 3, a well-known device using a resistance line strain gauge, a piezoelectric element, a magnetoresistive element, or the like can be used.

In the construction of FIG. 1, by moving the tool 4 by the driving of each joint of the robot arm 1 on the basis of control of the controlling apparatus 2 and driving the actuators at a desired position, the claws 11 to 13 are opened or closed and such an operation that the workpiece or the like is grasped or the like can be executed.

At this time, while a reaction force (stress) which is caused in each of the claws 11 to 13 of the tool 4 is detected by the force sensor 3, by feeding back its detecting quantities to an operation quantity, an object such as a workpiece or the like can be operated while preventing a damage, deformation, or the like of the claws 11 to 13 or the workpiece.

In the actual manufacturing site or the like, prior to using the robot arm 1, the operation of the robot arm 1 can be programmed by using the master workpiece (jig) and a teaching pendant 25.

A workpiece 5 and a workpiece 6 illustrated in FIG. 1 construct a first workpiece and a second workpiece of the invention, respectively. It is desirable that the workpieces 5 and 6 are a pair of master workpieces which are used when the operation at the time of handling the workpiece (part) as a working target by the robot arm 1 is programmed or the like. The master workpieces are formed by the same shape and size as those of the workpieces which are actually used in the manufacturing site or the like, desirably, at a dimension accuracy higher than that of the actual workpieces, respectively. There is a case where the workpieces 5 and 6 are hereinbelow called master workpieces 5 and 6.

The master workpieces 5 and 6 have one and the other of a convex portion and a concave portion which are mutually fitted, are operated by the robot arm 1 and the tool 4, and are coupled in a predetermined final coupling positional relation. Such a coupling operation which is illustrated as an example in the embodiment is an operation for fitting the master workpiece 5 into the master workpiece 6.

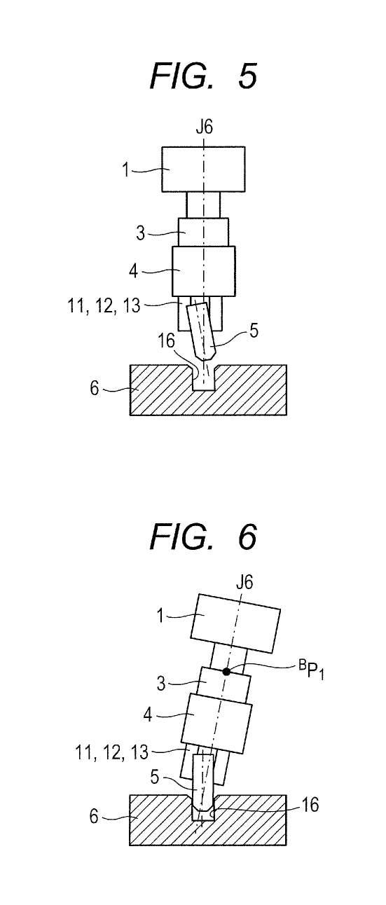

The master workpiece 5 of the embodiment has an almost cylindrical shape. A bore 16 into which the master workpiece 5 can be fitted is formed in the master workpiece 6. The master workpiece 6 is fixed onto a platform (not shown). The master workpiece 5 is grasped by the claws 11 to 13 of the tool 4 mounted to the robot arm 1. After that, the master workpiece 5 is fitted into the bore 16 of the master workpiece 6 in order as illustrated in FIGS. 5 to 7, which will be described hereinafter. In the embodiment, at the time of teaching using the master workpieces 5 and 6, an axial offset correcting process of the tool coordinate system, which will be described hereinafter, is executed. A correction (calibration) quantity which can be exerted when the workpieces correlated to the master workpieces 5 and 6 are actually operated is stored into a storing unit such as a RAM 23 or the like.

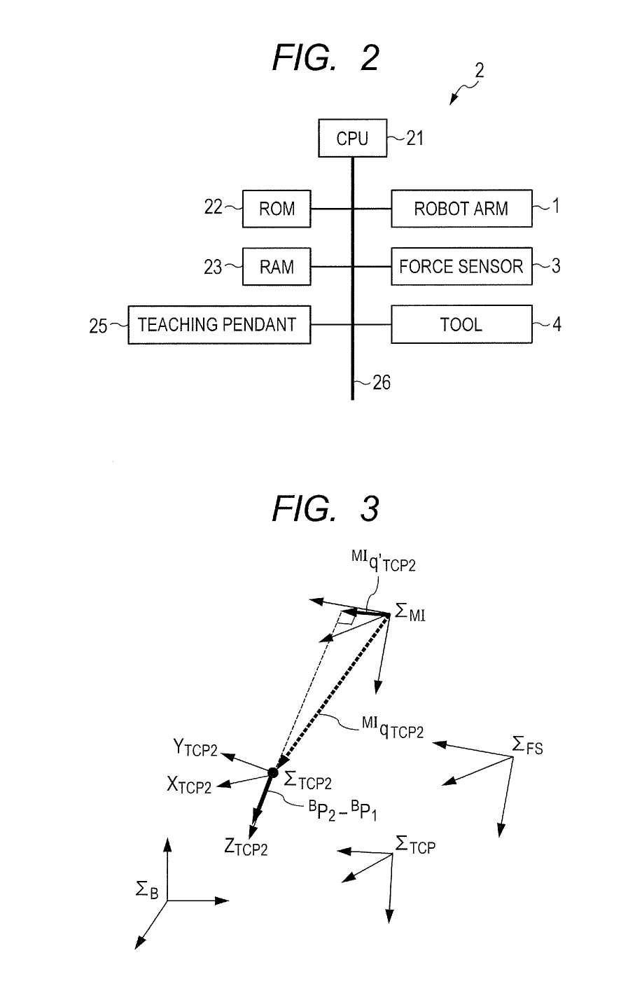

FIG. 2 is a block diagram illustrating the controlling apparatus 2 for controlling the robot arm 1. The controlling apparatus 2 is constructed in such a manner that the robot arm 1, force sensor 3, tool 4, and teaching pendant 25 are connected through a bus 26 to a computer main body constructed by a CPU 21, a ROM 22, the RAM 23, and the like. As for an interface for connecting each of the foregoing blocks, it is sufficient to use a well-known interface unit suitable for input/output specifications of each block and is not shown in FIG. 2.

In the robot system of FIGS. 1 and 2, a position and a position and orientation of each unit of the robot arm, tool (end effector), and the like are controlled by the controlling apparatus 2. In this case, the position and motion of each unit are controlled by using the coordinate system such as base coordinate system, mechanical interface coordinate system, tool coordinate system (end effector coordinate system), or the like as a reference. The base coordinate system among them becomes a reference of the whole robot system and is arranged by using a mounting surface or the like of the base of the robot as a reference. The mechanical interface coordinate system is a coordinate system in which the end effector (tool) mounting surface is used as a reference.

The tool coordinate system (end effector coordinate system) is a coordinate system which is used for the drive control of the tool, particularly, it is used to control the position and the position and orientation of each unit of the tool. The tool coordinate system is set to a predetermined position of an edge of the end effector (tool) on the basis of data showing the position and the position and orientation of the end effector edge when seen from the mechanical interface. Ordinarily, the tool coordinate system is set to the predetermined position in accordance with a structure of the end effector (tool) and design dimensions of the claws or the like mounted to the edge.

The CPU 21 controls the robot arm 1 and the tool 4 on the basis of various kinds of programs stored in the ROM 22 or RAM 23, settings which are input from the teaching pendant 25, or the like. For example, the CPU 21 allows the axial offset correction of the tool coordinate system to be executed in accordance with a tool coordinate system axial offset correcting program which was stored in the ROM 22 or RAM 23 and which will be described hereinafter. Various kinds of programs, control data, and the like have been stored in the ROM 22. The RAM 23 is used as a work area of the CPU 21.

An area of a programmable ROM such as an (E)EPROM or the like is also included in the ROM 22. In the following embodiment, a description will be made on the assumption that data obtained by a correcting (calibrating) arithmetic operation, which will be described hereinafter, or the like is stored into an area in the programmable ROM. However, it is not always necessary that the correcting (calibrating) arithmetic operation data or the like is stored into the ROM 22 but may be stored into the RAM 23 or another external storage device (not shown) in accordance with system requirements or other circumstances.

In the construction of FIGS. 1 and 2, by allowing the robot arm 1 to operate the master workpiece 5 by using the master workpieces 5 and 6 and the teaching pendant 25, the subsequent operation to the workpiece in the manufacturing site or the like can be programmed. The programmed operation is stored into the ROM 22 (or the RAM 23, another external storage device, or the like) of the controlling apparatus 2 by a predetermined recording format so that it can be used in the case of actually handling the workpiece later. For example, as illustrated in FIGS. 5 to 7, the operation to the workpiece in the embodiment is an operation to couple (hereinbelow, also referred to as “fit”) the master workpiece 5 to the master workpiece 6.

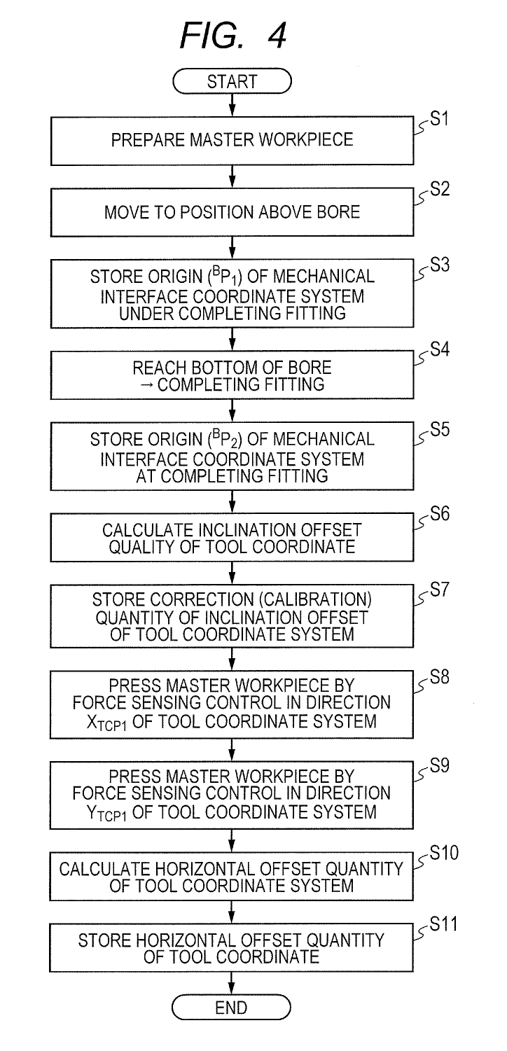

In the embodiment, when the fitting operation of the robot arm 1 is programmed, by controlling as illustrated in FIG. 4 by the controlling apparatus 2, a correction (calibration) quantity necessary to be exerted on the fitting operation control of the master workpieces 5 and 6 (or workpieces) is obtained. In this control, first, the master workpieces 5 and 6 are prepared (step S1 in FIG. 4). In this instance, each time the master workpiece 6 is fixed onto the platform (not shown) or the like, the master workpiece 5 is grasped by the claws 11 to 13 of the tool 4.

After that, the robot arm 1 is operated by using the teaching pendant 25 and the like and the master workpiece 5 is moved to a position above the bore 16 of the master workpiece 6 (step S2) and the operation to fit the master workpiece 5 into the bore 16 (steps S3 to S4) is started.

As mentioned above, there is a case where at a stage before the master workpiece 5 is actually fitted into the master workpiece 6, that is, at a point of time when the master workpiece 5 has been grasped by the tool as illustrated in FIG. 5, an offset of an inclination occurred between the central axis of the master workpiece 5 and the rotation central axis of the tool coordinate system. Such an “inclination offset” of the tool coordinate system occurs in accordance with specific characteristics such as precision, shape, and affinity of the claws 11 to 13 and the master workpiece 5 (or workpiece which is actually used in the site) as mentioned above.

In the embodiment, after the master workpiece 5 was come into contact with the bore 16 of the master workpiece 6, while the position and orientation of the master workpiece 5 are controlled through force control, which will be described hereinafter, using the force sensor 3, the master workpiece 5 is inserted into the bore 16 of the master workpiece 6 as illustrated in FIG. 6. During the fitting operation of the master workpieces 5 and 6, for example, in a certain state after the start of the fitting, a position (^{B}P₁ in FIG. 6) of an origin of the mechanical interface coordinate system (which will be described hereinafter) is stored into the ROM 22 or the like of the controlling apparatus 2 (step S3).

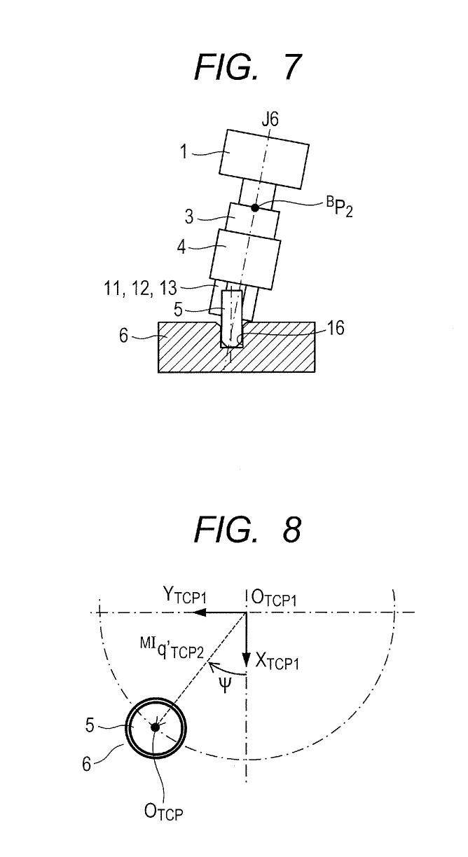

The fitting operation through the force control reaches a final coupling state as illustrated in FIG. 7 (step S4). In addition to the position ^{B}P₁ of the origin stored as mentioned above, in the embodiment, in a state which further differs from it, for example, in the final coupling state in FIG. 7, a position (^{B}P₂ in FIG. 7) of the origin of the mechanical interface coordinate system is stored into the ROM 22 or the like of the controlling apparatus 2 (step S5).

As mentioned above, in the embodiment, in at least two different states during the fitting operation, at least two different positions of the origin of the mechanical interface coordinate system to which the tool 4 has been mounted are stored into the ROM 22 or the like of the controlling apparatus 2. The positions of the origin of the mechanical interface coordinate system which are stored are, for example, ^{B}P₁ in FIG. 6 and ^{B}P₂ in FIG. 7. As for the two different positions of the origin of the mechanical interface coordinate system during the fitting operation of the master workpieces 5 and 6, the correction (calibration) quantity necessary to correct the “inclination offset” of the tool coordinate system has been reflected. Therefore, on the basis of the two different positions of the origin of the mechanical interface coordinate system stored into the ROM 22 or the like, the inclination offset quantity from the central axis of the master workpiece of the tool coordinate system can be calculated by using an arithmetic expression as will be mentioned hereinafter (step S6).

That is, in the embodiment, in at least two different states during the fitting operation which is executed while exerting the force control using the force sensor 3, the different positions (^{B}P_{I}, ^{B}P₂) of the origin of the mechanical interface coordinate system to which the tool 4 has been mounted are stored. The inclination offset quantity from the central axis of the master workpiece 5 of the tool coordinate system can be calculated as a necessary correction (calibration) quantity (step S7).

In the embodiment, after the master workpieces 5 and 6 were fitted in the vertical direction so as to have a predetermined positional relation as mentioned above, further, an offset of a distance from the central axis of the master workpiece 5 to the rotation central axis of the tool coordinate system is corrected, that is, the horizontal offset correction is performed (steps S8 to S11 in FIG. 4).

First, in a state after the fitting in the vertical direction of the master workpieces 5 and 6, the force control is made by using the force sensor 3 in such a manner that the master workpiece 5 is pressed to the master workpiece 6 by a predetermined force in the direction of an X axis (X_{TCP1}, which will be described hereinafter) of the tool coordinate system after the inclination offset correction. At this time, a force in the X axis (X_{TCP1}, which will be described hereinafter) direction and a torque around a Z axis (Z_{TCP1}, which will be described hereinafter) are detected by using the force sensor 3 (step S8 in FIG. 4). The force control of the robot arm 1 is made in such a manner that the master workpiece 5 is pressed to the master workpiece 6 by a predetermined force in the direction of a Y axis (Y_{TCP1}) of the tool coordinate system after the inclination offset correction. At this time, a force in the Y axis (Y_{TCP1}, which will be described hereinafter) direction and the torque around the Z axis (Z_{TCP1}, which will be described hereinafter) are detected by using the force sensor 3 (step S9).

Further, the horizontal offset quantity of the tool coordinate system is calculated by using the force in the X axis direction and the torque around the Z axis obtained in step S8 and the force in the Y axis direction and the torque around the Z axis obtained in step S9 by using arithmetic expressions as will be described hereinafter (step S10). A correction (calibration) quantity necessary to correct the horizontal offset of the tool coordinate system is obtained from the obtained horizontal offset quantity and stored into the ROM 22 (step S11).

An outline of the programming of the robot arm 1 in the embodiment and the axial offset correcting process including the inclination offset correction (steps S1 to S7 in FIG. 4) of the rotation central axis of the tool coordinate system and the horizontal offset correction (steps S8 to S11 in FIG. 4) of the tool coordinate system which are executed at that time has been described above. An arithmetic operation in the foregoing correcting process will be described in detail hereinbelow.

An outline of the coordinate system of the robot system in the embodiment is illustrated in FIG. 3. In FIG. 3, a base coordinate system (coordinate system set onto a base bottom surface of the robot arm 1) and a mechanical interface coordinate system are shown by Σ_{B} and Σ_{MI}, respectively.

The base coordinate system Σ_{B} is also called a coordinate system set onto the base bottom surface of the robot arm 1. The mechanical interface coordinate system Σ_{MI} is a coordinate system set to a mechanical interface at an edge of the robot arm 1 and is also called a flange coordinate system.

A tool coordinate system before the axial offset correcting process, which will be described hereinafter, is exerted and a tool coordinate system after the axial offset correction are shown by Σ_{TCP} and Σ_{TCP2}, respectively. A force sensor coordinate system (coordinate system which has been set to the force sensor) is shown by Σ_{FS}.

The X axis, Y axis, and Z axis of each coordinate system, a unit vector in the X axis direction, a unit vector in the Y axis direction, and a unit vector in the Z axis direction are expressed in a format in which a suffix is added to each of X, Y, Z, n, o, and a, respectively. For example, the Z axis of the tool coordinate system Σ_{TCP} before the axial offset correction is shown by Z_{TCP}. The unit vector in the Z_{TCP} axis direction of the tool coordinate system Σ_{TCP} before the axial offset correction when seen from the mechanical interface coordinate system Σ_{MI} is shown by ^{MI}a_{TCP}.

Subsequently, in the axial offset correcting process of the tool coordinate system of the robot in the embodiment, parameters showing an axial offset degree will be described.

A rotation matrix to perform a coordinate transformation from the mechanical interface coordinate system Σ_{MI} to the tool coordinate system Σ_{TCP2} after the axial offset correction is shown by ^{MI}R_{TCP2}, and a position vector is shown by ^{MI}q_{TCP2}. A homogeneous transformation matrix ^{MI}T_{TCP2} from the mechanical interface coordinate system Σ_{MI} to the tool coordinate system Σ_{TCP2} after the axial offset correction is expressed by the following equation (1).

$${}_{}^{MI}{T}{}_{TCP 2}^{} = [ \begin{matrix}{}_{}^{MI}{R}{}_{TCP 2}^{} & {}_{}^{MI}{q}{}_{TCP 2}^{} \\ 0 & 1\end{matrix} ] \qquad ( 1 )$$

Where, the homogeneous transformation matrix ^{MI}T_{TCP2} is a (4×4) matrix, the rotation matrix ^{MI}R_{TCP2} is a (3×3) matrix, and the position vector ^{MI}q_{TCP2} is a (3×1) matrix.

The rotation matrix ^{MI}R_{TCP2} is a matrix to rotate the mechanical interface coordinate system Σ_{MI} around the Z_{MI} axis and a Y′_{MI} axis in this order by angles φ and θ. The Y′_{MI} axis is a Y axis of a coordinate system Σ_{MI}, obtained by rotating the mechanical interface coordinate system Σ_{MI} around the Z_{MI} axis by the angle φ. It is now assumed that a matrix to rotate the mechanical interface coordinate system Σ_{MI} around the Z_{MI} axis by the angle φ is shown by Rot(φ, Z) and a matrix to rotate the mechanical interface coordinate system Σ_{MI}, around the Y′_{MI} axis by the angle θ is shown by Rot(θ, Y). Those matrices Rot(φ, Z) and Rot(θ, Y) are expressed by the following equations (2) and (3), respectively.

$$\begin{matrix}Rot ( φ , Z ) = [ \begin{matrix}cos φ & - sin φ & 0 \\ sin φ & cos φ & 0 \\ 0 & 0 & 1\end{matrix} ] & ( 2 ) \\ Rot ( φ , Y ) = [ \begin{matrix}cos θ & 0 & sin θ \\ 0 & 1 & 0 \\ - sin θ & 0 & cos θ\end{matrix} ] & ( 3 )\end{matrix}$$

By using the matrices Rot(φ, Z) and Rot(θ, Y), the rotation matrix ^{MI}R_{TCP2} of the equation (1) is expressed by the following equation (4).

^{MI}R_{TCP2}=Rot(φ,Z)·Rot(θ,Y) (4)

Assuming that a vector in which the position vector ^{MI}q_{TCP2} is projected to an X_{TCP2} Y′_{TCP2} plane of the tool coordinate system Σ_{TCP2} after the axial offset correction is shown by ^{MI}q′_{TCP2} (FIG. 3), the position vector ^{MI}q_{TCP2} is expressed by the following equation (5).

^{MI}q_{TCP2}=^{MI}q′_{TCP2}+k·^{MI}a_{TCP2} (5)

Where, k is a constant and _{MI}a_{TCP2} is a unit vector in the Z_{TCP2} axis direction after the axial offset correction when seen from the mechanical interface coordinate system Σ_{MI}.

In order to perform the axial offset correction of the tool coordinate system so as to rotate the tool 4 around the central axis of the master workpiece 5 grasped by the three claws 11, 12, and 13 of the tool 4, it is necessary to correct the Z_{TCP} axis of the tool coordinate system Σ_{TCP} so as to coincide with the central axis of the master workpiece 5. For this purpose, it is sufficient to obtain such angles θ and φ of the rotation matrix ^{MI}R_{TCP2} and the projection vector ^{MI}q′_{TCP2} that the Z_{TCP2} axis of the tool coordinate system Σ_{TCP2} after the axial offset correction coincides with the central axis of the master workpiece 5.

In the embodiment, an arithmetic operating process for obtaining the angles θ and φ of the rotation matrix ^{MI}R_{TCP2} and correcting the inclination offset of the tool coordinate system is called “inclination offset correcting step”. An arithmetic operating process for obtaining the projection vector ^{MI}q′_{TCP2} and correcting the horizontal offset of the tool coordinate system is called “horizontal offset correcting step”.

The axial offset correcting method of the tool coordinate system Σ_{TCP} of the robot arm 1 using the master workpieces 5 and 6 will be described in detail hereinbelow with reference to FIGS. 4 to 10 again in addition to FIGS. 1 to 3 in consideration of the foregoing items as a prerequisite.

[1] Inclination Offset Correcting Step (Steps S1 to S7 in FIG. 4)

The inclination offset correcting step (S1 to S7 in FIG. 4) of the tool coordinate system will now be described with reference to FIGS. 5 to 7.

First, the master workpiece 5 is grasped by the claws 11, 12, and 13 of the tool 4 and the master workpiece 6 is fixed onto the platform (not shown) (step S1). It is sufficient that the position where the master workpiece 6 is arranged lies within a movable range of the robot arm 1.

Subsequently, after the robot arm 1 was moved to a position above the bore 16 of the master workpiece 6, the fitting of the master workpiece 5 into the master workpiece by the force control is started (step S2). FIG. 5 schematically illustrates a state before the inclination offset calculating operation is started. It is assumed that the operating direction of the robot arm 1 at this time is the Z_{TCP} axis direction of the tool coordinate system Σ_{TCP} before the axial offset correction.

At a point of time of starting the operation, since the central axis of the master workpiece 5 and the central axis of the master workpiece 6 ordinarily do not coincide, the master workpieces 5 and 6 are come into contact with each other at a certain point of time after the start of the movement in the Z_{TCP} axis direction and forces in 6 directions which occur by the contact are detected by the force sensor 3. In the embodiment, the force control is performed on the basis of the 6-directional forces detected by the force sensor 3 at this time and the position and orientation of the robot arm 1 are controlled so that the central axis of the master workpiece 5 and the central axis of the master workpiece 6 coincide.

As for the force controlling method which is used in the inclination offset correction of the embodiment, any force controlling method may be used so long as the coupling (fitting) operation of the master workpieces 5 and can be controlled. In this instance, for example, damping control is applied as a force controlling method. The damping control is such control that velocities in the directions of the X, Y, and Z axes of the robot arm 1 and target values V_{ref} of rotation angular velocities of the R_{X}, R_{Y}, and R_{Z} axes around the respective axes are corrected in accordance with differences between 6-directional force target values F_{ref} and a force Fₑₓₜ detected by the force sensor (equation 6).

V=V_{ref}+D⁻¹(Fₑₓₜ−F_{ref}) (6)

Where, V is a matrix showing an actual velocity of the robot arm 1 of (6×6); V_{ref} is a target velocity matrix of (6×6); D is a viscosity matrix of (6×6) as a damping value; Fₑₓₜ is an external force matrix detected by the force sensor; and F_{ref} is a target force matrix. In the embodiment, an origin O_{TCP} of the tool coordinate system Σ_{TCP} before the axial offset correction is controlled in accordance with the equation (6). The external force Fₑₓₜ detected by the force sensor is coordinate transformed from the force sensor coordinate system Σ_{FS} to the tool coordinate system Σ_{TCP} before the axial offset correction in such a manner that the origin O_{TCP} of the tool coordinate system Σ_{TCP} before the axial offset correction becomes an operating point.

In the damping control in the embodiment, the target velocity is applied only to the Z_{TCP} axis direction and the other axes are come to rest unless otherwise the external force is detected. The angle around the Z_{TCP} axis is fixed. That is, if the equation (6) in the embodiment is divided into axial components and is described, it is expressed by the following equations (7).

$${V}_{XTCP} = \frac{1}{{D}_{XTCP}} {F}_{XTCPext} \\ {V}_{YTCP} = \frac{1}{{D}_{YTCP}} {F}_{YTCPext} \\ {V}_{ZTCP} = {V}_{ZTCPref} + \frac{1}{{D}_{ZTCP}} ( {F}_{ZTCPext} - {F}_{ZTCPref} ) \\ {ω}_{RXTCP} = \frac{1}{{D}_{RXTCP}} {T}_{RXTCPext} \\ {ω}_{RYTCP} = \frac{1}{{D}_{RYTCP}} {T}_{RYTCPext} \\ {ω}_{RZTCP} = 0 \qquad ( 7 )$$

Where, in the above equations, V_{XTCP}, V_{YTCP}, and V_{ZTCP} are actual velocities in the X_{TCP}, Y_{TCP}, and Z_{TCP} axis directions, and ω_{RXTCP}, ω_{RYTCP}, and ω_{RZTCP} are angular velocities in the R_{XTCP}, R_{YTCP} and R_{ZTCP} axis directions, respectively. D_{XTCP}, D_{YTCP}, D_{ZTCP}, D_{RXTCP}, and D_{RYTCP} are damping values in the X_{TCP}, Y_{TCP}, Z_{TCP}, R_{XTCP}, and R_{YTCP} axis directions, respectively. F_{ZTCPref} is a target force in the Z_{TCP} axis direction. F_{XTCPext}, F_{YTCPext}, F_{ZTCPext}, T_{RXTCPext}, and T_{RYTCPext} are external forces in the X_{TCP}, Y_{TCP}, Z_{TCP}, R_{XTCP}, and R_{YTCP} axis directions detected by the force sensor 3, respectively.

As mentioned above, in the force control which is used in the inclination offset correction in the embodiment, when the operation of the robot arm is controlled by using the detecting quantity of the force sensor, a predetermined damping value is exerted on the basis of the detecting quantity of the force sensor, and damping control to decide the velocity of the robot arm is performed.

After the master workpieces 5 and 6 were come into contact with each other, the fitting of the master workpieces 5 and 6 is progressed through the foregoing force control. A position and a position and orientation of the origin O_{MI} of the mechanical interface coordinate system Σ_{MI} when seen from the base coordinate system Σ_{B} in a state where the master workpiece 5 has been inserted to a certain extent as illustrated in FIG. 6 are stored as ^{B}P₁ into the ROM 22 (step S3). At this time, it is necessary that timing for obtaining the position ^{B}P₁ of the origin is in a state where the central axis of the master workpiece 5 and the central axis of the master workpiece 6 coincide, and a state where the master workpiece 6 has been inserted into the master workpiece 6 to a depth which is almost equal to a diameter of the master workpiece 5 or more.

Subsequently, the insertion of the master workpiece 5 is further progressed and when an edge of the master workpiece 5 reaches a bottom portion of the bore 16 of the master workpiece 6, the fitting operation is finished (step S4). A position and a position and orientation of the origin O_{MI} of the mechanical interface coordinate system Σ_{MI} when seen from the base coordinate system Σ_{B} at this point of time are stored as ^{B}P₂ into the ROM 22 (step S5). FIG. 7 is an explanatory diagram schematically illustrating a state where the insertion of the master workpiece 5 has been completed.

If ^{B}P₁ and ^{B}P₂ obtained as mentioned above are used, a vector showing the central axis of the master workpiece 5 when seen from the base coordinate system Σ_{B} is expressed by ^{B}P₂ ^{B}P₁.

Subsequently, an inclination offset quantity of the central axis of the master workpiece 5 to the Z_{MI} axis of the mechanical interface coordinate system Σ_{MI} is calculated (step S6). As mentioned above, in order to perform the inclination offset correction, it is sufficient to obtain such angles θ and φ of the rotation matrix ^{MI}R_{TCP1} that the Z_{TCP1} axis of a tool coordinate system Σ_{TCP1} after the axial offset correction coincides with the central axis of the master workpiece 5.

A tool coordinate system τ_{TCP2} in which only the inclination offset has been corrected will now be defined. It is assumed that the tool coordinate system Σ_{TCP1} in which only the inclination offset has been corrected has the same orientation as that of the tool coordinate system Σ_{TCP2} after the axial offset correction and an origin ^{B}O_{TCP1} of the coordinate system Σ_{TCP1} is the same as an origin ^{B}O_{MI} of the mechanical interface coordinate system Σ_{MI}. That is, a homogeneous transformation matrix ^{MI}T_{TCP1} from the mechanical interface coordinate system Σ_{MI} to the tool coordinate system Σ_{TCP1} in which only the inclination offset has been corrected is expressed by the following equation (8). A position vector ^{B}q_{TCP1} from the base coordinate system Σ_{B} to the tool coordinate system Σ_{TCP1} is expressed by the following equation (9).

$${}_{}^{MI}{T}{}_{TCP 1}^{} = [ \begin{matrix}{}_{}^{MI}{R}{}_{TCP 1}^{} & 0 \\ 0 & 1\end{matrix} ] \qquad ( 8 )$$

^{B}q_{TCP1}=^{B}q_{MI} (9)

The rotation matrix ^{MI}R_{TCP1} in the Equation (8) is the same as the rotation matrix ^{MI}R_{TCP2} from the mechanical interface coordinate system Σ_{MI} to the tool coordinate system Σ_{TCP2} after the axial offset correction in accordance with its definition (equation 10).

$$\begin{matrix}{}_{}^{MI}{R}{}_{TCP 1}^{} = {}_{}^{MI}{R}{}_{TCP 2}^{} \\ = Rot ( φ , Z ) \cdot Rot ( θ , Y )\end{matrix} \qquad ( 10 )$$

A unit vector ^{B}a_{TCP1} in a Z_{TCP1}′ axis direction of a tool coordinate system Σ_{TCP1}′ in which only the inclination offset when seen from the base coordinate system Σ_{B} has been corrected is expressed by the following equation (11).

$$[ \begin{matrix}{}_{}^{B}{a}{}_{TCP 1}^{} \\ 1\end{matrix} ] = {}_{}^{B}{T}{}_{MI}^{} \cdot {}_{}^{MI}{T}{}_{TCP 1}^{} \cdot [ \begin{matrix}{}_{}^{TCP 1}{a}{}_{TCP 1}^{} \\ 1\end{matrix} ] \qquad ( 11 )$$

Where, it is assumed that a homogeneous transformation matrix ^{B}T_{MI} from the base coordinate system Σ_{B} to the mechanical interface coordinate system Σ_{MI} in the equation (11) has been well known (equation 12).

$${}_{}^{B}{T}{}_{MI}^{} = [ \begin{matrix}{}_{}^{B}{R}{}_{M 1}^{} & {}_{}^{B}{q}{}_{MI}^{} \\ 0 & 1\end{matrix} ] \qquad ( 12 )$$

A unit vector ^{TCP1}a_{TCP1} in the Z_{TCP1} axis direction when seen from the tool coordinate system Σ_{TCP1} in which only the inclination offset has been corrected is expressed by the following equation (13) in accordance with its definition.

^{TCP1}a_{TCP1}=[0 0 1]^{T} (13)

Since the unit vector ^{B}a_{TCP1} in the Z_{TCP1} axis direction when seen from the base coordinate system Σ_{B} has the same orientation as that of (^{B}P₂−^{B}P₁) which has already been obtained, it is expressed by the following equation (14).

$${}_{}^{B}{a}{}_{TCP 1}^{} = {}_{}^{B}{q}{}_{TCP 1}^{} + \frac{{}_{}^{B}{P}{}_{2}^{} - {}_{}^{B}{P}{}_{1}^{}}{\vert {}_{}^{B}{P}{}_{2}^{} - {}_{}^{B}{P}{}_{1}^{} \vert} \qquad ( 14 )$$

The equation (11) can be expressed by the following equation (15) from the equations (8), (12), and (14).

$$\begin{matrix}[ {}_{}^{B}{q}{}_{TCP 1}^{} + \frac{{}_{}^{B}{P}{}_{2}^{} - {}_{}^{B}{P}{}_{1}^{}}{\vert {}_{}^{B}{P}{}_{2}^{} - {}_{}^{B}{P}{}_{1}^{} \vert} ] = [ \begin{matrix}{}_{}^{B}{R}{}_{MI}^{} & {}_{}^{B}{q}{}_{MI}^{} \\ 0 & 1\end{matrix} ] [ \begin{matrix}{}_{}^{MI}{R}{}_{TCP 1}^{} & 0 \\ 0 & 1\end{matrix} ] [ \begin{matrix}{}_{}^{B}{a}{}_{TCP 1}^{} \\ 1\end{matrix} ] \\ = [ \begin{matrix}{}_{}^{B}{R}{}_{MI}^{} \cdot {}_{}^{MI}{R}{}_{TCP 1}^{} \cdot {}_{}^{TCP 1}{a}{}_{TCP 1}^{} + {}_{}^{B}{q}{}_{MI}^{} \\ 1\end{matrix} ]\end{matrix} \qquad ( 15 )$$

Further, the equation (15) can be expressed by the following equation (16) from the equations (2), (3), (9), (10), and (13).

$$\frac{{}_{}^{B}{P}{}_{2}^{} - {}_{}^{B}{P}{}_{1}^{}}{\vert {}_{}^{B}{P}{}_{2}^{} - {}_{}^{B}{P}{}_{1}^{} \vert} = {}_{}^{B}{R}{}_{MI}^{} \cdot [ \begin{matrix}cos φ & - sin φ & 0 \\ sin φ & cos φ & 0 \\ 0 & 0 & 1\end{matrix} ] [ \begin{matrix}cos θ & 0 & sin θ \\ 0 & 1 & 0 \\ - sin θ & 0 & cos θ\end{matrix} ] [ \begin{matrix}0 \\ 0 \\ 1\end{matrix} ] \qquad ( 16 )$$

By solving the equation (16), the angles φ and θ are derived as inclination offset quantities of the tool coordinate system.

Subsequently, by using the angle offset quantities φ and θ of the tool coordinate system which have already been obtained, a correction (calibration) quantity of the angle offset of the tool coordinate system is recorded (step S7). That is, the angle offset quantities φ and θ obtained as mentioned above are written into a predetermined area in the ROM 22 of the controlling apparatus 2, and the angle offset correction of the tool coordinate system is completed. At this time, the tool coordinate system obtained by correcting the angle offset is Σ_{TCP1} which has already been defined.

As mentioned above, in the embodiment, the master workpiece 5 is grasped by the tool 4 and, while controlling the position of the master workpiece 5 by using the detecting quantities of the force sensor 3, the fitting of the master workpiece 5 into the master workpiece 6 is started. The position of the central axis of the master workpiece 5 is obtained on the basis of at least two different positions of the origin of the mechanical interface coordinate system to which the tool 4 has been mounted in at least two different states during the fitting operation. A process for calculating the inclination offset of the tool coordinate system on the basis of the position of the central axis of the master workpiece 5 and correcting the inclination offset of the tool coordinate system on the basis of the calculated inclination offset is executed as a first step.

[2] Horizontal Offset Correcting Step (Steps S8 to S11 in FIG. 4)

Subsequently, the horizontal offset correcting step of the tool coordinate system will be described with reference to FIGS. 8 to 10.

FIG. 8 is a diagram illustrating a state of the master workpieces 5 and 6 before the start of the horizontal offset calculating operation according to the embodiment of the invention when seen from the Z_{TCP1} axis direction of the tool coordinate system Σ_{TCP1} after the inclination offset correction.

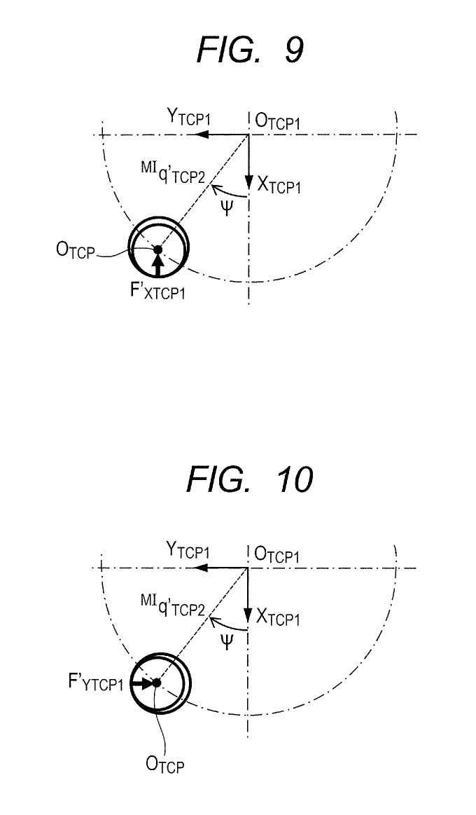

First, in a state where the fitting of the master workpiece 5 has been completed, the force control of the robot arm 1 is made in such a manner that the master workpiece 5 is pressed to the master workpiece 6 by a predetermined force in the X_{TCP1} axis direction of the tool coordinate system Σ_{TCP1} after the inclination offset correction. At this time, a force in the X_{TCP1} axis direction and a torque around the Z_{TCP1} axis are detected by using the force sensor 3 (step S8). FIG. 9 is a diagram illustrating a state of the master workpieces 5 and 6 in the case where the master workpiece 5 has been pressed only in the X_{TCP1} axis direction by a predetermined force when seen from the Z_{TCP1} axis direction of the tool coordinate system Σ_{TCP1} after the inclination offset correction.

As for the force controlling method which is used in the horizontal offset correction (in the X axis direction) of the embodiment, any force controlling method may be used so long as the operation for pressing the master workpiece 5 to the master workpiece 6 by the predetermined force can be executed. In this instance, for example, damping control is used as a force controlling method. Damping controlling equations regarding the velocities in the X_{TCP1}, Y_{TCP1}, and Z_{TCP1} axis directions of the robot arm 1 in the horizontal offset correction (in the X axis direction) of the embodiment and the rotation angular velocities around the R_{XTCP1}, R_{YTCP1}, and R_{ZTCP1} axes are expressed by the following equations (17).

$${V}_{XTCP 1} = \frac{1}{{D}_{XTCP 1}} ( {F}_{XTCP 1 ext} - {F}_{XTCP 1 ref} ) \\ {V}_{YTCP 1} = \frac{1}{{D}_{YTCP 1}} {F}_{YTCP 1 ext} \\ {V}_{ZTCP 1} = 0 \\ {ω}_{RXTCP 1} = 0 \\ {ω}_{RYTCP 1} = 0 \\ {ω}_{RZTCP 1} = 0 \qquad ( 17 )$$

Where, V_{XTCP1}, V_{YTCP1}, and V_{ZTCP1} are actual velocities in the X_{TCP1}, Y_{TCP1}, and Z_{TCP1} axis directions. ω_{RXTCP1}, ω_{YTCP1}, and ω_{RZTCP1} are angular velocities in the R_{xTCP1}, R_{YTCP1}, and R_{ZTCP1} axis directions, respectively. D_{XTCP1} and D_{YTCP1} are damping values in the X_{TCP1} and Y′_{TCP1} axis directions, respectively. F_{XTCP1ref} is a target force in the X_{TCP1} axis direction. F_{XTCP1ext} and F_{YTCP1ext} are external forces in the X_{TCP1} and Y_{TCP1} axis directions detected by the force sensor 3, respectively.

It is now assumed that a force in the X_{TCP1} axis direction and a torque around the Z_{TCP1} axis which were detected by the force sensor 3 when the master workpiece 5 has been pressed to the master workpiece 6 in the X_{TCP1} axis direction by the predetermined force are shown by F′_{XTCP1} and M′_{ZTCP1} respectively. It is now assumed that an angle between a vector ^{MI}q′_{TCP2} in which the position vector ^{MI}q_{TCP2} from the mechanical interface coordinate system Σ_{MI} to the tool coordinate system Σ_{TCP2} after the axial offset correction has been projected to the X_{TCP2}Y_{TCP2} plane and a unit vector ^{TCP1}n_{TCP1} in the X_{TCP1} axis direction is shown by Ψ. In this case, a relation between F′_{XTCP1} and M′_{ZTCP1} is expressed by the following equation (18).

M′_{ZTCP1}=|^{MI}q′_{TCP2}|·sin ψ·F′_{XTCP1} (18)

As mentioned above, in the force control which is used in the horizontal offset correction (in the X axis direction) of the embodiment, the operation of the robot arm is controlled by using the detecting quantities of the force sensor. At this time, such damping control that a predetermined damping value is exerted on the basis of the detecting quantities of the force sensor and the velocity of the robot arm is decided is performed.

Subsequently, the force control of the robot arm 1 is performed in such a manner that the master workpiece 5 is pressed to the master workpiece 6 by the predetermined force in the Y_{TCP1} axis direction of the tool coordinate system Σ_{TCP1} after the angle offset correction. At this time, a force in the Y_{TCP1} axis direction and a torque around the Z_{TCP1} axis are detected by using the force sensor (step S9). FIG. 10 is a diagram illustrating a state of the master workpieces 5 and 6 in the case where the master workpiece 5 has been pressed only in the Y_{TCP1} axis direction by a predetermined force when seen from the Z_{TCP1} axis direction of the tool coordinate system Σ_{TCP1} after the inclination offset correction.

As for the force controlling method which is used in the horizontal offset correction (in the Y axis direction) of the embodiment, any force controlling method may be used so long as the operation for pressing the master workpiece 5 to the master workpiece 6 by the predetermined force can be executed. In this instance, for example, damping control is used as a force controlling method. Damping controlling equations regarding the velocities in the X_{TCP1}, Y_{TCP1}, and Z_{TCP1} axis directions of the robot arm 1 in the horizontal offset correction (in the Y axis direction) of the embodiment and the rotation angular velocities around the R_{XTCP1}, R_{YTCP1}, and R_{ZTCP1} axes are expressed by the following equations (19).

$${V}_{XTCP 1} = \frac{1}{{D}_{XTCP 1}} {F}_{XTCP 1 ext} \\ {V}_{YTCP 1} = \frac{1}{{D}_{YTCP 1}} ( {F}_{YTCP 1 ext} - {F}_{YTCP 1 ref} ) \\ {V}_{ZTCP 1} = 0 \\ {ω}_{RXTCP 1} = 0 \\ {ω}_{RYTCP 1} = 0 \\ {ω}_{RZTCP 1} = 0 \qquad ( 19 )$$

Where, in the equations (19), F_{YTCP1ref} is a target force in the Y′_{TCP1} axis direction. Other character expressions are similar to those in the equations (17).

It is now assumed that a force in the Y′_{TCP1} axis direction and a torque around the Z_{TCP1} axis which were detected by the force sensor 3 when the master workpiece 5 has been pressed to the master workpiece 6 only in the Y′_{TCP1} axis direction by the predetermined force are shown by F′_{YTCP1} and M″_{ZTCP1}, respectively. In this case, a relation between F′Y_{TCP1} and M″_{ZTCP1} is expressed by the following equation (20).

M″_{ZTCP1}=−|^{MI}q′_{TCP2}|·cos ψ·F′_{YTCP1} (20)

As mentioned above, in the force control which is used in the horizontal offset correction (in the Y axis direction) of the embodiment, the operation of the robot arm is controlled by using the detecting quantities of the force sensor. At this time, such damping control that a predetermined damping value is exerted on the basis of the detecting quantities of the force sensor and the velocity of the robot arm is decided is performed.

Subsequently, a horizontal offset quantity of the tool coordinate system is calculated (step S10). As mentioned above, in order to perform the horizontal offset correction, it is sufficient to obtain the projection vector ^{MI}q′_{TCP2}. At this time, an orientation of the tool coordinate system Σ_{TCP1} after the inclination offset correction is the same as that of the tool coordinate system Σ_{TCP2} after the axial offset correction. Therefore, a component of the X_{TCP2} axis direction and a component of the Y_{TCP2} axis direction of the vector ^{MI}q′_{TCP2} projected to the X_{TCP2}Y_{TCP2} plane are expressed by the following equations (21) and (22) from the equations (18) and (20), respectively.

$$\begin{matrix}\vert {}_{}^{MI}{q}{}_{TCP 2}^{′} \vert \cdot cos ψ = - \frac{{M}_{ZTCP 1}^{″}}{{F}_{YTCP 1}^{′}} & ( 21 ) \\ \vert {}_{}^{MI}{q}{}_{TCP 2}^{′} \vert \cdot sin ψ = \frac{{M}_{ZTCP 1}^{′}}{{F}_{XTCP 1}} & ( 22 )\end{matrix}$$

Subsequently, a correction (calibration) quantity of the horizontal offset quantity of the tool coordinate system obtained by the equations (21) and (22) is recorded (step S11). That is, the horizontal data of the tool coordinate system obtained by the equations (21) and (22) is written into a predetermined area in the ROM 22 of the controlling apparatus 2. At this time, the tool coordinate system in which both of the inclination offset correction and the horizontal offset correction were performed, that is, the tool coordinate system after the axial offset correction is Σ_{TCP2} which has already been defined.

As mentioned above, in the embodiment, after the master workpieces 5 and 6 were fitted, while controlling the position of the master workpiece 5 by using the detecting quantities of the force sensor 3, the master workpiece 5 is pressed to the master workpiece 6 in two horizontal directions crossing the direction of fitting of those two members, respectively. At this time, a force and a torque exerted on the master workpiece 5 are detected by the force sensor 3. A process for calculating the horizontal offset of the tool coordinate system on the basis of the detecting quantities of the force sensor 3 and correcting the horizontal offset of the tool coordinate system on the basis of the calculated horizontal offset is executed as a second step.

As mentioned above, the axial offset correction of the tool coordinate system of the embodiment is constructed by the inclination offset correction of the tool coordinate system (S1 to S7 in FIG. 5) and the horizontal offset correction (S8 to S11 in FIG. 5). The foregoing first and second steps, that is, the inclination offset correcting process (S1 to S7 in FIG. 5) and the horizontal offset correcting step (S8 to S11 in FIG. 5) can be stored as an axial offset correcting program into, for example, the ROM 22.

The axial offset correcting program stored in the ROM 22 can be exerted as a calibrating process in the case where, for example, while the operator operates the robot arm 1 by using the master workpieces 5 and 6 through the teaching pendant 25, the operation of the workpieces is programmed. For example, after the master workpiece 5 grasped by the three claws 11, 12, and 13 of the tool 4 was moved to a position above the bore 16 of the master workpiece 6, by executing the foregoing axial offset correcting program stored in the ROM 22, the inclination offset correction and the horizontal offset correction can be performed. The inclination offset correction quantity and the horizontal offset correction quantity of the tool coordinate system obtained at this time can be stored into the ROM 22 (a programmable ROM area in the ROM 22, the RAM 23, or the like) and can be exerted at the time of actually assembling the workpiece. Thus, when a phase of the workpiece is corrected and the coupling operation such as a fitting or the like is executed, problems such as increase in load on the workpiece, increase in tact time which is required for the coupling operation, and the like can be avoided.

As described above, according to the axial offset correction of the tool coordinate system of the embodiment, not only the horizontal offset correction of the tool coordinate system but also the inclination offset correction can be performed. Therefore, as compared with the case where only the horizontal offset correction of the tool coordinate system was performed, for example, when the tool (end effector) has been rotated around the rotation central axis of the tool coordinate system, a positional offset of the master workpiece (jig) grasped by the tool or the workpiece can be reduced. Thus, when the phase of the grasped master workpiece or workpiece is corrected and the coupling operation such as a fitting or the like is executed, the problems such as increase in load on the master workpiece or workpiece, increase in tact time which is required for the coupling operation, and the like can be avoided.

Each step of the inclination correction of the tool coordinate system and the horizontal offset correction constructing the axial offset correction control of the invention can be executed by a computer (CPU) constructing a main control unit of the controlling apparatus for controlling the robot system. Each of the foregoing steps constructing the axial offset correction control of the invention can be implemented as a tool coordinate system correcting program of the computer (CPU) constructing the main control unit of the controlling apparatus for controlling the robot system. A computer-readable recording medium such as ROM in which such a tool coordinate system correcting program has been recorded, various kinds of programmable ROMs, or the like can be assembled into the main control unit of the controlling apparatus for controlling the robot system. For the purpose of repair, mending, upgrading, or the like, such a tool coordinate system correcting program can be recorded into various kinds of computer-readable recording media and supplied to a specific robot system as a target. Data media of arbitrary formats such as optical disks of various kinds of formats, flash memory, semiconductor disk like an SSD or the like, magnetic disk like an HDD or the like, and the like are included in the foregoing computer-readable recording media.

Although the embodiment of the invention has been described above, the invention is not limited only to the foregoing embodiment. Effects of the invention are not limited only to the effects disclosed in the foregoing embodiment.

For example, although the embodiment has been described by using the robot arm 1 of 6-axis vertical multi-joint, the invention is not limited to such a construction. For example, the invention can be desirably embodied in an arbitrary robot system having a robot arm of multi-axis and multi-joint (the number of axes and the number of joints may be equal to arbitrary numbers) with an edge axis.

Although the embodiment has been described by using the tool 4 having the three claws 11, 12, and 13 as an end effector which is mounted to the robot arm 1 and used, the invention is not limited to such a construction. Naturally, the invention can be also embodied in, for example, a robot system or the like using a robot hand having a plurality of claws such as two or four claws as a tool (end effector).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the foregoing construction, not only the horizontal offset correction of the tool coordinate system but also the inclination offset correction can be performed. Therefore, according to the invention, as compared with the case where only the horizontal offset correction of the tool coordinate system was performed as shown in the related art, there is such an excellent effect that the loads to the cylindrical parts at the time of mutually fitting the cylindrical parts and the tact which is required for the fitting can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-030598, filed Feb. 20, 2014, which is hereby incorporated by reference herein in its entirety.

What is claimed is:

1. A method of correcting a tool coordinate system of a robot system comprising a robot arm having a mounting surface on which a tool is mounted to be driven under a control using a tool coordinate system, and being controlled according to a mechanical interface coordinate system correlated to the mounting surface, a force sensor, and a controlling apparatus configured to control an operation of the robot arm, wherein, using a first workpiece having a convex potion and a second workpiece having a concave portion capable of fitting the convex potion, the first workpiece is grasped by the tool, to fit the concave portion of the first workpiece to the concave portion of the second workpiece, and wherein, under a controlling by the controlling apparatus, the method comprises:
grasping the first workpiece by the tool;
controlling the operation of the robot arm based on a detecting quantity of the force sensor, to start the fitting of the first workpiece to the second workpiece, to calculate a position of an origin of the mechanical interface coordinate system at least at two states during the operation of the fitting, to calculate a position of a central axis of the first workpiece;
calculating an offset quantity of an inclination of the tool coordinate system based on the position of the central axis of the first workpiece; and
correcting the offset quantity of the inclination of the tool coordinate system based on the calculated offset of the inclination.

2. The method according to claim 1, wherein
after the fitting of the first workpiece to the second workpiece, the operation of the robot arm is controlled based on the detecting quantity of the force sensor,
a horizontal offset quantity of the tool coordinate system is calculated based on the detecting quantity of the force sensor under a condition that the first workpiece is pressed to the second workpiece in horizontal two directions crossing a direction of fitting the first workpiece to the second workpiece, and
a horizontal offset of the tool coordinate system is corrected based on the calculated horizontal offset quantity.

3. The method according to claim 1, wherein
the workpiece is a master workpiece.

4. The method according to claim 1, further comprising
a damping control to determine a speed of the robot arm based on the detecting quantity of the force sensor.

5. A program for operating a computer to execute the method according to claim 1.

6. A non-transitory computer-readable recording medium storing a readable program for operating a computer to execute the method according to claim 5.

7. A robot system comprising:
a robot arm having a mounting surface on which a tool is mounted to be driven under a control using a tool coordinate system, and being controlled according to a mechanical interface coordinate system correlated to the mounting surface;
a force sensor; and
a controlling apparatus configured to control an operation of the robot arm, wherein, using a first workpiece having a convex potion and a second workpiece having a concave portion capable of fitting the convex potion, the first workpiece is grasped by the tool, to fit the concave portion of the first workpiece to the concave portion of the second workpiece, and wherein the controlling apparatus controls such that
the first workpiece is grasped by the tool,
the operation of the robot arm is controlled based on a detecting quantity of the force sensor, to start the fitting of the first workpiece to the second workpiece, to calculate a position of an origin of the mechanical interface coordinate system at least at two states during the operation of the fitting, to calculate a position of a central axis of the first workpiece,
an offset quantity of an inclination of the tool coordinate system is calculated based on the position of the central axis of the first workpiece, and
the offset quantity of the inclination of the tool coordinate system is corrected based on the calculated offset of the inclination.

8. The robot system according to claim 7, wherein
after the fitting of the first workpiece to the second workpiece, the operation of the robot arm is controlled based on the detecting quantity of the force sensor,
a horizontal offset quantity of the tool coordinate system is calculated based on the detecting quantity of the force sensor under a condition that the first workpiece is pressed to the second workpiece in horizontal two directions crossing a direction of fitting the first workpiece to the second workpiece, and
a horizontal offset of the tool coordinate system is corrected based on the calculated horizontal offset quantity.
